(19) United States
(12) Patent Application Publication
(10) Pub. No.: US 2006/0171714 A1
(43) Pub. Date: Aug. 3, 2006

(54) Electrically shared passive optical network

(75) Inventor: Jason Dove, Novato, CA (US)

Correspondence Address: SILICON VALLEY PATENT GROUP LLP, 2350 MISSION COLLEGE BOULEVARD, SUITE 360, SANTA CLARA, CA, 95054, US

(73) Assignee: Calix Networks, Inc.

(21) Appl. No.: 11/050,375

(22) Filed: Feb. 2, 2005

(51) Int. Cl. H04J 14/00

(52) U.S. Cl. 398/71

(57) ABSTRACT

An optical line terminal (OLT) includes a media access controller (MAC) that has a transmit bus coupled to several optical transceivers by one or more electrical splitters. Each optical transceiver is coupled, in the normal manner, to a passive optical network (PON). All PONs that are coupled to the MAC transmit the same signal in the downstream direction which is the signal driven by the MAC on its transmit bus. Therefore, a signal generated by a single MAC is split in the electrical domain in the OLT, in addition to being split in the optical domain by the PONs. Splitting of signals in the electrical domain in the OLT eliminates MACs that are otherwise required.

### BACKGROUND

Cable television signals are frequently supplied by a headend to a node in a neighborhood of homes over an optical fiber, and the neighborhood node in turn supplies the cable TV signal on a coaxial cable to one or more buildings in the neighborhood. Coaxial cables typically consist of an inner copper conductor, an aluminum wrap that in turn is overlaid with a shield of copper or aluminum braid. Cable TV signals are carried on the inner copper conductor while the wrap and the braid are connected to ground. A coaxial cable (called “trunk”) that is downstream of the neighborhood node, is typically split by a splitter that is connected to multiple coaxial cables. These multiple coaxial cables are each connected to a TV in a home or apartment building. Each time a coaxial cable is split, the cable TV signal is also split. Hence, it is common to use one or more amplifiers to boost a radio frequency (RF) component in the cable TV signal, prior to splitting. Such amplifiers may be powered by line power voltage, such as a square wave direct current (DC) voltage which is also carried by the same coaxial cable that carries the RF signal.

An electrical network formed by coaxial cables downstream of a neighborhood node (that terminates the optical fiber from the headend) typically includes numerous drip loops, service loops and ground wire loops associated with various locally installed devices such as ground blocks, multiple signal splitter devices, multiple jumper cables. Considerable time, cable, and components are commonly required to expand such an electrical network to support additional TVs.

U.S. Pat. No. 4,370,516 granted to Bailey, Jr. et al. on Jan. 25, 1983 describes electrical splitters for a coaxial cable network that are standardized, and this patent is incorporated by reference herein in its entirety. Moreover, U.S. Pat. No. 5,950,111 granted to Georger et al. on Sep. 7, 1999 describes passively splitting a coaxial cable TV signal (using no active devices) for distribution to multiple unshielded twisted-pair cables, and this patent is also incorporated by reference herein in its entirety.

Cable TV splitter of the type described above are illustrated by, for example, UHF/VHF Miniature Indoor Hybrid Splitters, such as parts 75-506 and 75-508 manufactured by Calrad Electronics 819 N. Highland Ave. Los Angeles, Calif. 90038, Phone 323-465-2131 and available from the distributor Cal-Centron Wholesale Co of Stockton, Calif., Phones 800.252-2094 and 209.942.2094. Note that these splitters are electrical and passive (i.e. no electrical power is used).

Another kind of communication network in the access space is a Passive Optical Network (PON). A PON typically couples an optical line terminal (OLT) at a central location such as a telecommunication service provider's central office or a cable television network's headend to a number of optical network terminals (ONTs) located on subscriber's premises. A key feature of conventional PONs is that all their optical distribution components are passive—i.e. not use any electrical power—their optical distribution components typically include optical fibers, and optical splitters and/or optical couplers.

In one such conventional system, illustrated in FIG. 1A, an optical line terminal (OLT) 10 broadcasts a single optical signal in the downstream direction over an optical fiber 11 of a PON, and an optical splitter 12 splits this single optical signal across a number of optical fibers 13-15 that are coupled to a corresponding number of optical network terminals ONT A, ONT B and ONT C. Each ONT receives the entire signal which is broadcast by OLT 10, and each ONT selectively processes only information which belongs to itself, e.g. ONT A only process data received in a timeslot “A” relative to the beginning of a frame, which happens to be the very first time slot in FIG. 1A, and ONT “C” only processes data received in a timeslot “C” which happens to be the very last time slot in FIG. 1A.

For more information on PONs, see the following patents, each of which is incorporated by reference herein in its entirety as background: U.S. Pat. 4,977,593 granted to Balance on Dec. 11, 1990, U.S. Pat. No. 5,073,982 granted to Viola et al. on Dec. 17, 1991, U.S. Pat. No. 5,285,305 granted to Cohen et al on Feb. 8, 1994, U.S. Pat. No. 5,311,344 granted to Wood et al on May 10,1994, U.S. Pat. No. 5,661,585 granted to Feldman et al on Aug. 26,1997, U.S. Pat. No. 5,854,701 granted to Clarke et al. on Dec. 29,1998, U.S. Pat. No. 6,636,527 granted to Lee et al. on Oct. 21, 2003 and U.S. Pat. No. 6,411,410 granted to Wright et al on Jun. 25, 2002.

Two standards organizations which have recently developed standards for PONs are: Ethernet in the First Mile Alliance (EFMA) responsible for IEEE 802.3ah standard and Full Service Access Networks (FSAN) responsible for ITU-T's G.983 and G.984 standards. Specifically, one recently developed PON version is IEEE 802.3ah which is commonly called Ethernet PON (EPON) in which all services are carried over 1.25 Gbps PON network using Ethernet encapsulation (voice, video, data are all mapped into Ethernet MAC frames and carried over the network). Another recently developed PON version is G.984 which is called Gigabit PON (GPON) defined by ITU-T in which all services are mapped over a downstream 1.2/2.4 Gbps PON network in their native format using either ATM or GEM (GPON Encapsulation Method). An older PON version is G.983 which is also called Broadband PON (BPON) and supports a downstream 155/622 Mbps rate.

A prior art PON system 20 (FIG. 1B) is described in U.S. Pat. No. 6,801,547 granted to Boyd et al. on Oct. 5, 2004 that is incorporated by reference herein in its entirety as background. As shown in FIG. 1, an optical line terminal (OLT) 22 is connected to a passive optical power splitter 34 by a single optical fiber 36. PON system 20 further includes ONUs 28a, 28b connected to splitter 36 by optical fibers 38,40. The OLT includes a laser 24, e.g., a 1500 nm laser, for downstream transmission. In addition, the OLT can include a burstmode receiver 26, e.g., tuned for receiving at 1300 nm. Similarly, the ONUs can include a transmitting laser 32a, and a receiver 30a. OLT 22 also includes a media access controller (MAC) 25 that contains a scheduler. The MAC controls the transport of various digital data streams between the OLT and the ONUs.

Note that the MAC 25 of FIG. 1B has a single transmit bus (not labeled) that is connected to a single laser 24 for downstream transmission. Moreover, MAC 25 has a single receive bus (also not labeled) that is connected to a single receiver 26. This architecture, in which a media access controller (MAC) is connected to only one downstream laser and only one upstream receiver is common in all passive optical networks (PONs) known to the inventor.

Downstream transmission in PON system 20 of FIG. 1B is via point-to-multipoint broadcast from the OLT 22 to all (active) ONUs 28a, 28b over the downstream fiber network. Upstream transmission is via individual point-to-point transmission from the respective ONUs 28a, 28b to OLT 22 over the upstream fiber network. MAC 25 encodes data into preselected slots for transmission to individual ONUs (relative to the beginning of the frame as discussed in reference to FIG. 1A), and then passes the frame to laser 24 where the whole frame is transmitted on to the single optical fiber 36. MAC 101 also transmits to the ONUs a signal which indicates when each ONU may access the shared optical medium for upstream transmission from the ONUs to the OLT.

U.S. Pat. No. 5,790,786 granted to Wakeman et al. on Aug. 4, 1998 is incorporated by reference herein in its entirety. This patent describes a multi-media-access-controller (henceforth “multi-MAC”) that includes a plurality of transmit data path circuits and a plurality of receive data path circuits that respectively transmit and receive data serially on a corresponding plurality of network buses, a single transmit data path controller and a single receive data path controller that monitor status of and control operation of the respective transmit and receive data path circuits. Use of only two data path controllers eliminates the plurality of MACs and therefore results in significant savings in die area. Use of a single CRC calculator also results in savings in die area.

### SUMMARY

In accordance with the invention, a passive optical network (PON) signal that is generated by a media access controller (MAC), for downstream transmission, is initially split in the electrical domain (by one or more electrical splitter(s)). Copies of the PON signal obtained from electrical splitting are then again split, this time in the optical domain, in a manner normal to passive optical networks (PONs).

Splitting a PON signal in the electrical domain prior to splitting in the optical domain, allows a number of lasers (e.g. two or four lasers) to be used in parallel to transmit the same PON signal to a corresponding number of PONs. Parallel use of multiple lasers eliminates the need for a single powerful laser otherwise needed in the prior art. Moreover, the multiple lasers transmit the same PON signal, thereby eliminating the need for multiple media access controllers (MACs).

In many embodiments, an optical line terminal (OLT) includes a media access controller (MAC) that has a transmit bus coupled to several optical transmitters by one or more electrical splitters. Each optical transmitter in turn is coupled, in the normal manner, to a passive optical network (PON). All PONs that are coupled to a MAC transmit the same signal in the downstream direction (to all their ONTs), which is the signal driven by the MAC on its transmit bus.

Depending on the embodiment, any conventional MAC for a passive optical network may be used, with electrical splitters to split the PON signal being generated. The conventional MAC is configured to generate its PON signal in the normal manner, to address all ONTs connected to its transmit bus, regardless of the domain (electrical or optical) in which the PON signal is split, and regardless of the number of times the PON signal is split.

In addition, in some embodiments, upstream signals from individual PONs are combined in the electrical domain, by performing a Boolean OR operation, and the result is driven on a receive bus of the MAC. Note and alternate method could employ a multiplexer control by a MAC. Note and alternative implementation could use an upstream multiplexer controlled by a MAC generated selection signal; however; the OR'd approach is more MAC generic. The MAC processes the signal on the receive bus in the normal manner, to process the data that is received from all ONTs connected to its transmit bus.

### BRIEF DESCRIPTION OF THE FIGURES

FIG. 1A shows a transmission of a signal from a single central location to a number of subscriber premises via a Passive Optical Network (PON) of the prior art.

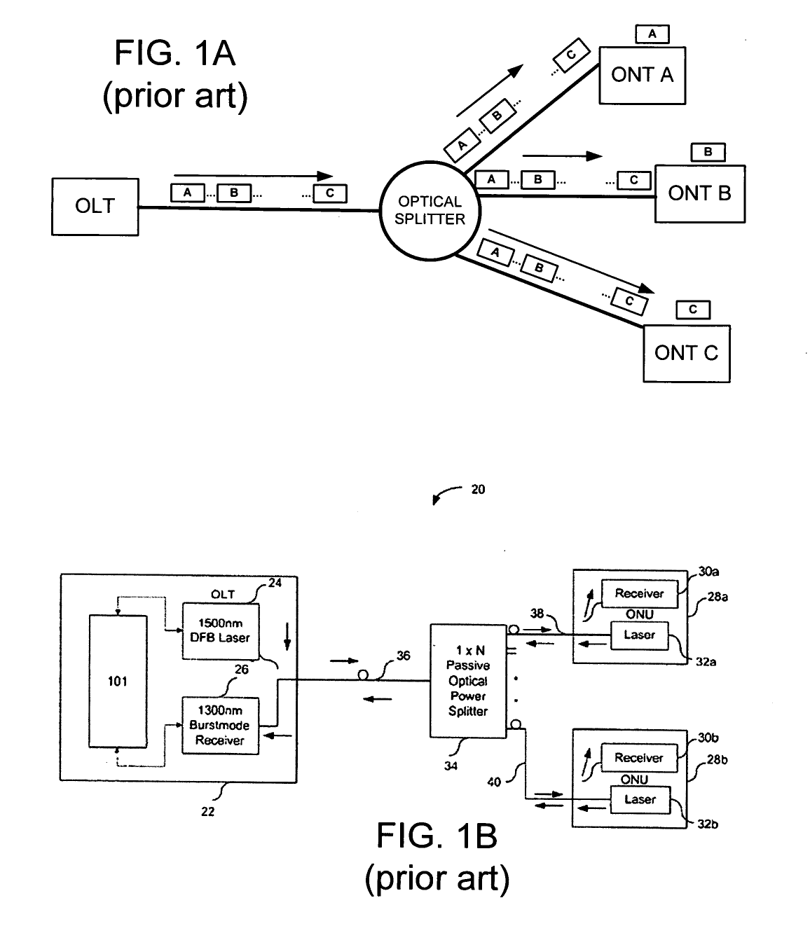

FIG. 1B shows, in a block diagram, components within each of: an optical line terminal (OLT), PON, and optical network units (ONUs). Note that the terms ONU and ONT are used interchangeably herein.

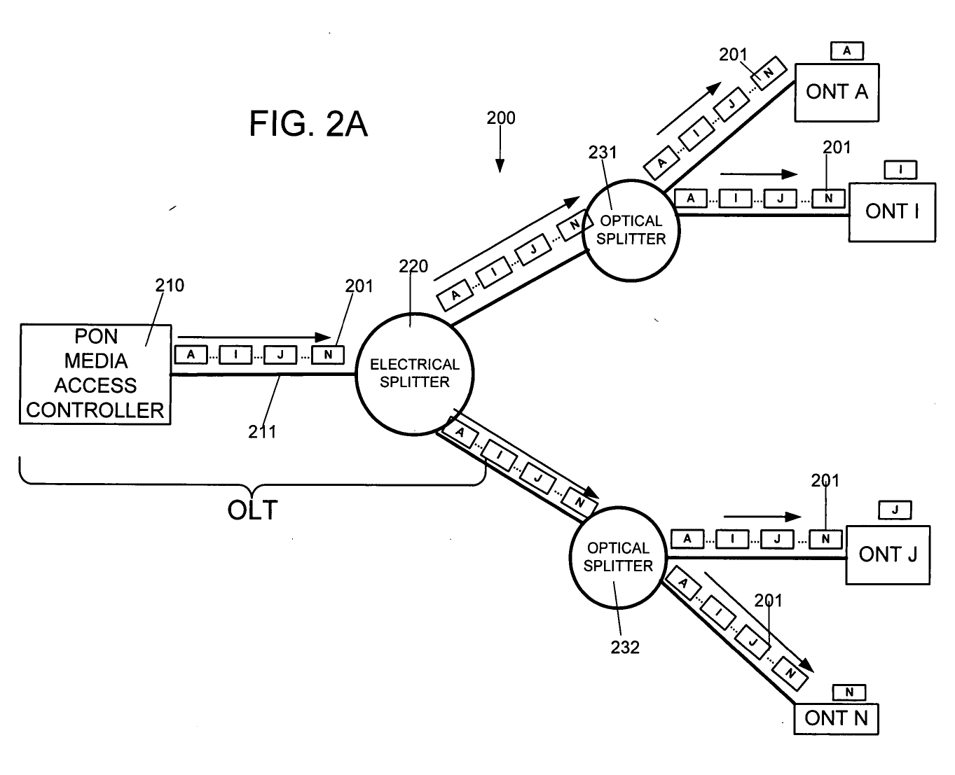

FIG. 2A illustrates several embodiments of the invention that split a PON signal in the electrical domain (by an electrical splitter) prior to transmission, followed by splitting in the optical domain (by an optical splitter) after transmission by lasers (not shown in FIG. 2A).

FIG. 2B illustrates, in a flow chart, acts that are performed by many embodiments of the invention.

FIG. 3A illustrates, in a high level block diagram, one embodiment of an OLT that includes, in accordance with the invention, at least one electrical splitter and an OR operator to combine the upstream signals from PONs.

FIG. 3B illustrates, in a high level block diagram, an alternative embodiment of an OLT that includes, in accordance with the invention, at least one electrical splitter and a multiplexer to combine the upstream signals from PONs.

FIG. 4 illustrates, in a detailed block diagram, one specific illustrative embodiment of an OLT that uses two Broadband PON (BPON) media access controllers and related circuitry in a single board.

FIGS. 5A-5C illustrate, in three intermediate level block diagrams, three embodiments of a passive optical network in accordance with the invention, including a fanout buffer, a demorganized NAND gate, a PON media access controller (including receive and transmit circuitry), and a pair of transceivers (including lasers and photosensors).

### DETAILED DESCRIPTION

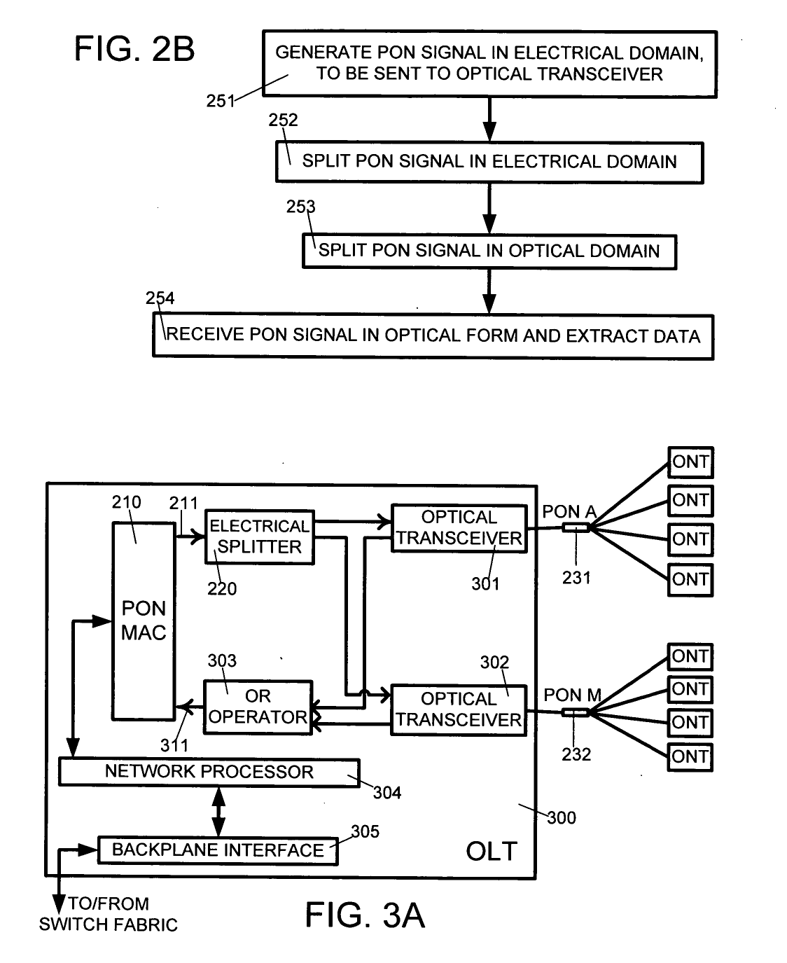

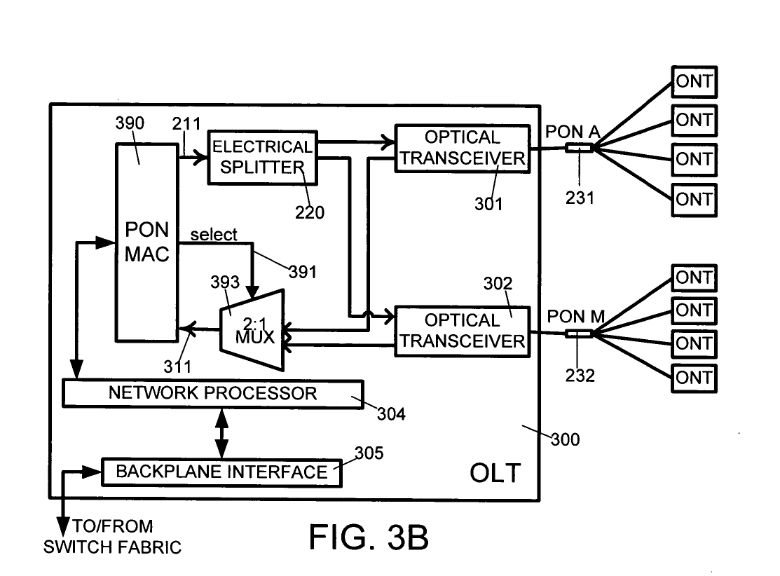

In an apparatus 200 (FIG. 2A) in accordance with the invention, a signal 201 that is generated by a PON media access controller 210 on its transmit bus 211 (as per act 251 in FIG. 2B) is initially split in its electrical form by an electrical splitter 220 (as per act 252 in FIG. 2B), and then again split this time in its optical form by passive optical splitter(s) 231 and 232 (as per act 253 in FIG. 2B). Electrical splitter 220 does not need to process electrical signal 201 in any manner, other than to split the signal. Hence, the same signal 201 is received (in an optical form) by each of optical splitters 231 and 232, and they supply this signal to all ONTs A-N coupled thereto.

PON media access controller 210 generates signal 201 with data for each of ONTs A-N in a manner normal to passive optical networks (PONs), regardless of the number or type of splits that are performed, as long as each ONT is coupled to transmit bus 211. Specifically, in FIG. 2A, all ONTs A, I, J and N receive the entire signal 201 in optical form and extract their individual data (as per act 254 in FIG. 2B). For example, in some embodiments, each ONT extracts its data from a given slot whose location relative to the start of frame in signal 201, is predetermined in the normal manner.

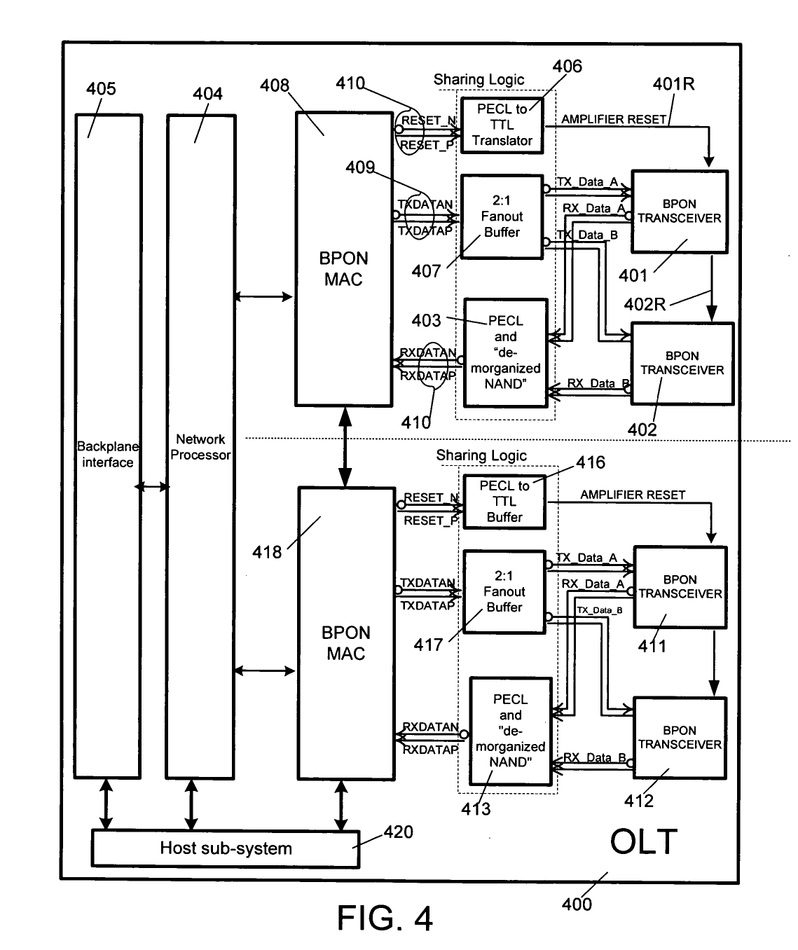

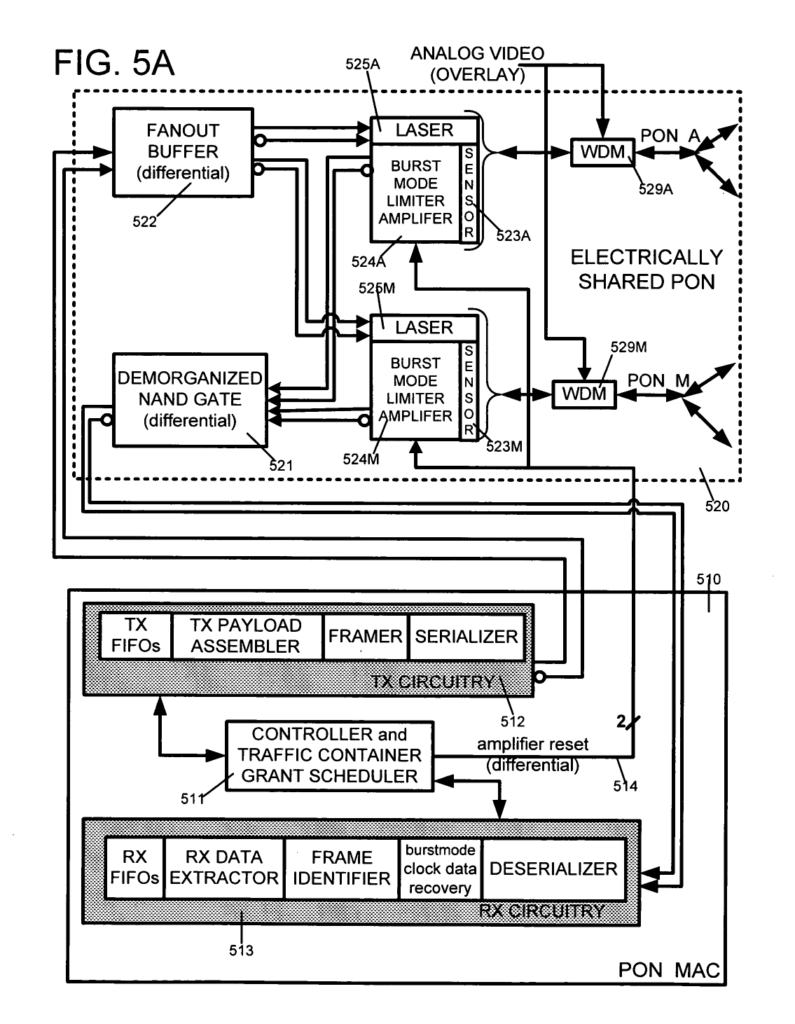

Note that although a single electrical splitter 220 and a single pair of optical splitters 231 and 232 are illustrated in the embodiment shown in FIG. 2A, any number of electrical splitters followed by any number of optical splitters may be present in between a first electrical splitter 220 (that is directly connected to the MAC 210) and a last optical splitter 231 (that is directly connected to one or more ONTs A-I) depending on the embodiment. After a last electrical splitter but before a first optical splitter, a copy of signal 201 transmitted therebetween is converted from the electrical domain (i.e. from its electrical form) into the optical domain (i.e. into its optical form) in the normal manner, e.g. by a corresponding number M of optical transceivers (not shown in FIG. 2A; see FIG. 3A, as described below).

In some embodiments of the invention, an optical line terminal (OLT) 300 (FIG. 3A) includes a media access controller (MAC) 210 that has a transmit bus 211 coupled to at least two optical transceivers 301 and 302 by at least one electrical splitter 220. Each optical transceiver 301 and 302 is coupled to a corresponding passive optical network PON A and PON M. Each of PON A and PON M is coupled to a group of optical network terminals (ONTs) by one or more passive optical devices, such as optical splitter(s) 231 and 232 and optical fibers (not labeled in FIG. 3A). Depending on the embodiment, optical splitters 231 and 232 may be implemented by fused optical fibers (to support a handful of ONTs) or wave guides (to support a larger number of ONTs).

In some embodiments, OLT 300 also includes digital logic in the form of an OR operator 303 that is coupled to each of the optical transceivers 301 and 302 of OLT 300, to receive therefrom the upstream signals from PON A and PON M. OR operator 303 combines upstream signals from PONs A and M by performing a Boolean OR operation, and supplies its output on a receive bus 311 of MAC 210. MAC 210 processes the combined upstream signal that is received from its receive bus 311 in the normal manner, i.e. regardless of the number of combinations in each of the two domains.

Note that OLT 300 also includes a network processor 304 that is coupled to MAC 210. Network processor 304 in turn is coupled by a backplane interface 305 to a switch fabric, in the normal manner. Network processor 304 may be used to perform Layer 2 functions not performed by MAC 210 and any additional Layer 3 functions. The functions of Layer 2 and 3 are described in International Standard Organization's Open System Interconnect (ISO/OSI) model, which is well known in the art.

OLT 300 (FIG. 3A) uses a single MAC 210 with multiple optical transceivers 301 and 302, by splitting and combining PON signals in their electrical forms, i.e. in the electrical domain (in addition to splitting and combining them in their optical forms, i.e. in the optical domain). Note that OLT 300 provides an inexpensive solution because the cost of electrical splitter 220 and OR operator 303 is negligible in reference to the cost of OLT 300. However, if a conventional OLT were to use a single MAC to support the same number of ONTs, that OLT would require a more powerful laser, in order to perform all splitting in the optical domain. On the other hand, if the same number of transceivers are used, the conventional OLT requires a corresponding number of MACs. Both types of conventional OLTs are expensive, because one requires a powerful laser and the other requires additional MACs.

To summarize, many embodiments in accordance with the invention use multiple lasers in parallel to carry the same PON signal, and hence eliminate the need for the power of an optical transmitter (such as a laser) to be scaled up by a number (e.g. two or four times), to compensate for a corresponding reduction in power when splitting, while at the same time using a single media access controller (MAC) thereby to reduce cost.

Note that although the embodiment of FIG. 3A uses an OR operator 301 to combine upstream signals from PON A and PON M, other embodiments combine the two upstream signals from these two PONs A and M, using other hardware, such as, for example a 2:1 multiplexer illustrated in FIG. 3B. Specifically, the OR operator 301 of FIG. 3A is replaced by a 2:1 multiplexer 393 in FIG. 3B. Moreover, in FIG. 3B, the corresponding MAC 390 is identical to the above-described MAC 210 in almost all respects except the following difference. MAC 390 of FIG. 3B is designed to generate a 1-bit select signal that is driven on a 1-bit bus 391 to control operation of the multiplexer 393. The selection signal is driven active or inactive on bus 391, depending on the time slots allocated to ONTs in the respective PONs A and M, by a time slot allocation mechanism. Such a time slot allocation mechanism is normally present in a traffic container grant scheduler that is normally included in a MAC for a passive optical network (i.e. PON MAC).

As would be apparent to the skilled artisan in view of this disclosure, the multiplexer 393 (FIG. 3B) uses the select signal to enable the upstream signal from one PON (e.g. PON A) while disabling the upstream signal from the other PON (e.g. PON M) if the current time is within a time slot allocated to an ONT in the one PON (i.e. PON A), and vice versa. Also as would be apparent to the skilled artisan in view of the disclosure, a 4:1 multiplexer (not shown) may be used in certain embodiments wherein the MAC produces a 2-bit select signal (on a 2-bit bus 391) that is used to select one of four different upstream signals (from four PONs) for passage to the MAC.

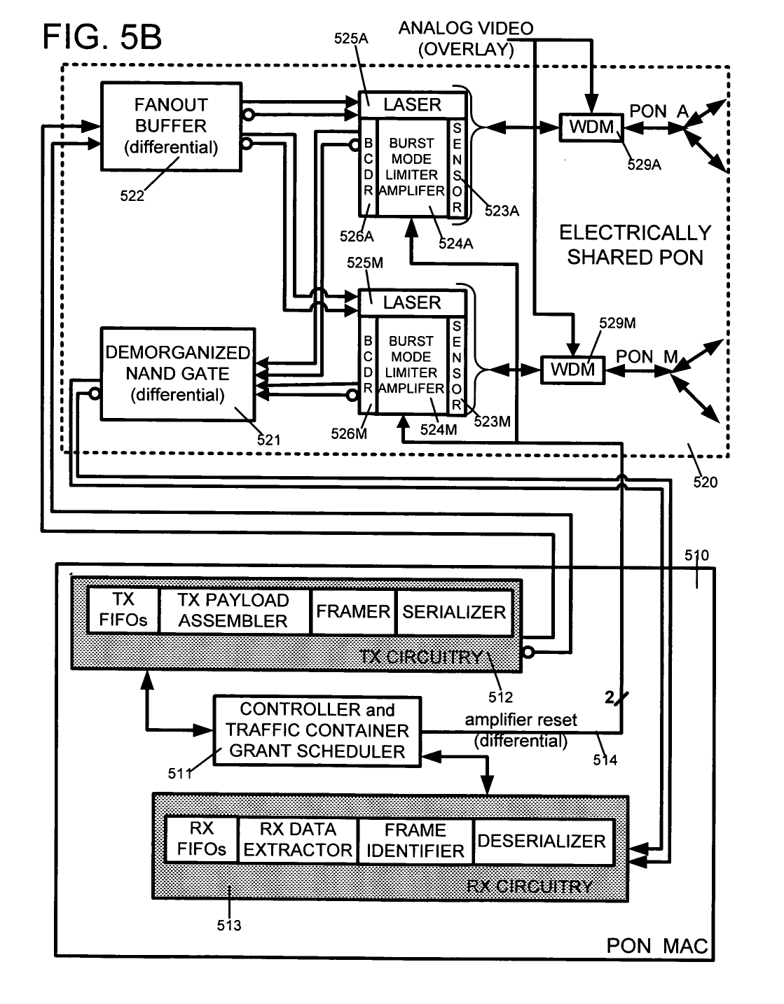

One specific embodiment and its illustrative implementation are now discussed in reference to OLT 400 which is illustrated in FIG. 4. Specifically, OLT 400 includes two MACs 408 and 418 that conform to the ITU-T specification G.983 for Broadband PON (BPON). BPON MACs 408 and 418 are coupled to a network processor 404 which in turn is coupled to a backplane interface 405 in the normal manner. All of the just-described components of OLT 400 are implemented as discrete blocks, each of which is coupled to a host subsystem 420 also in the normal manner.

BPON MAC 408 of this embodiment generates the PON signal as a differential signal on two lines TXDATAN and TXDATAP that are included in a transmit bus 409. Transmit bus 409 is coupled to a 2:1 fanout buffer 407 that accepts differential input. An example of fanout buffer 407 is the part SY58011U which is available from Micrel, Inc. of 1849 Fortune Drive, San Jose, Calif. 95131. Note that fanout buffer 407 of this embodiment is a Current Mode Logic (CML) device that accepts a differential LVPECL signal (wherein LVPECL stands for Low Voltage Low Power Emitter Coupled Logic) without need for any level-shifting or termination resistor networks in its signal path.

In this embodiment, fanout buffer 407 generates two output signals on differential buses TX_Data_A and TX_Data_B. Differential buses TX_Data_A and TX_Data_B are coupled to the respective transceivers 401 and 402. Transceivers 401 and 402 of OLT 400 also conform to the ITU-T specification G.983 for Broadband PON (BPON) and hence support 622 Mbps bandwidth in the downstream direction and 155 Mbps burst bandwidth in the upstream direction. An example of such a transceiver is the part BBT-L-61 which is available from BroadLight Inc. of 1300 Crittenden Lane, Suite 203 Mountain View, Calif. 94043.

Each of BPON transceivers 401 and 402 has a reset line respectively labeled as 401R and 402R. A signal on the reset line is typically used by a burst mode limiter amplifier (not shown) in BPON transceivers 401 and 402. Such an amplifier is described in, for example, U.S. Pat. No. 6,686,799 entitled “Burst Mode Limiter-Amplifier” granted to Ivry on Feb. 3, 2004 that is incorporated by reference herein in its entirety. The reset signal on lines 401R and 402R is supplied, in OLT 400 by a PECL to TTL Translator 406 that accepts differential input. Specifically, a differential input port of PECL to TTL Translator 406 is coupled to a bus 410 that carries an amplifier reset signal in differential form generated by MAC 408. An example of such a translator is the part SY10ELT21L available from Micrel, Inc. of 1849 Fortune Drive, San Jose, Calif. 95131.

OLT 400 also includes a demorganized NAND gate 403 that has two differential input ports each of which is coupled to a respective one of buses RX_Data_A and RX_Data_B. Buses RX_Data_A and RX_Data_B carry differential signals that are driven by the respective BPON transceivers 401 and 402. The differential signals represent upstream PON signals which are generated by transceivers 401 and 402 from bursts transmitted by individual ONTs coupled thereto by the respective PONs (such as PON A and PON M that are illustrated in FIG. 3A coupled to the respective ones of transceivers 301 and 302). Demorganized NAND gate 403 implements a Boolean OR function on the signals from buses RX_Data_A and RX_Data_B and supplies the resulting signal on a receive bus 410 of BPON media access controller 408.

Note that the above-described BPON media access controller 408 accepts differential input on receive bus 410. Hence bus 401 has two lines RXDATAN and RXDATAP to carry the differential signal. Moreover, the signals generated by the transceivers 401 and 402 are converted to PECL by the above-described demorganized NAND gate 403. An example of such a gate is the part SY10EP05V available from Micrel, Inc. of 1849 Fortune Drive, San Jose, Calif. 95131.

In one particular illustrative implementation, each of transceivers 401 and 402 may be coupled to a maximum of 32 ONTs (not shown in FIG. 4). In this implementation, all 64 ONTs are addressed by the single media access controller 408, in the normal manner. Specifically, media access controller 408 is configured to support 64 ONTs, as if all 64 ONTs were coupled to a single transceiver. However, OLT 400 uses two transceivers 401 and 402 (to transmit the same PON signal in parallel). Hence OLT 400 eliminates the need for a single transceiver that is twice as powerful, in order to service all 64 ONTs.

Note that in one embodiment, as illustrated in FIG. 4, OLT 400 has an additional BPON media access controller 418 that is coupled (in a manner similar to BPON media access controller 408) to translator 416, fanout buffer 417 and demorganized NAND gate 413, all of which are in turn coupled to BPON transceivers 411 and 412. Therefore, a single board OLT 400 illustrated in FIG. 4 actually supports a maximum of 128 ONTs. Note that the PON signal transmitted by the pair of transceivers 411 and 412 is different from the PON signal transmitted by transceivers 401 and 402, although within each pair the two transceivers carry the same PON signal (i.e. identical to one another within the pair).

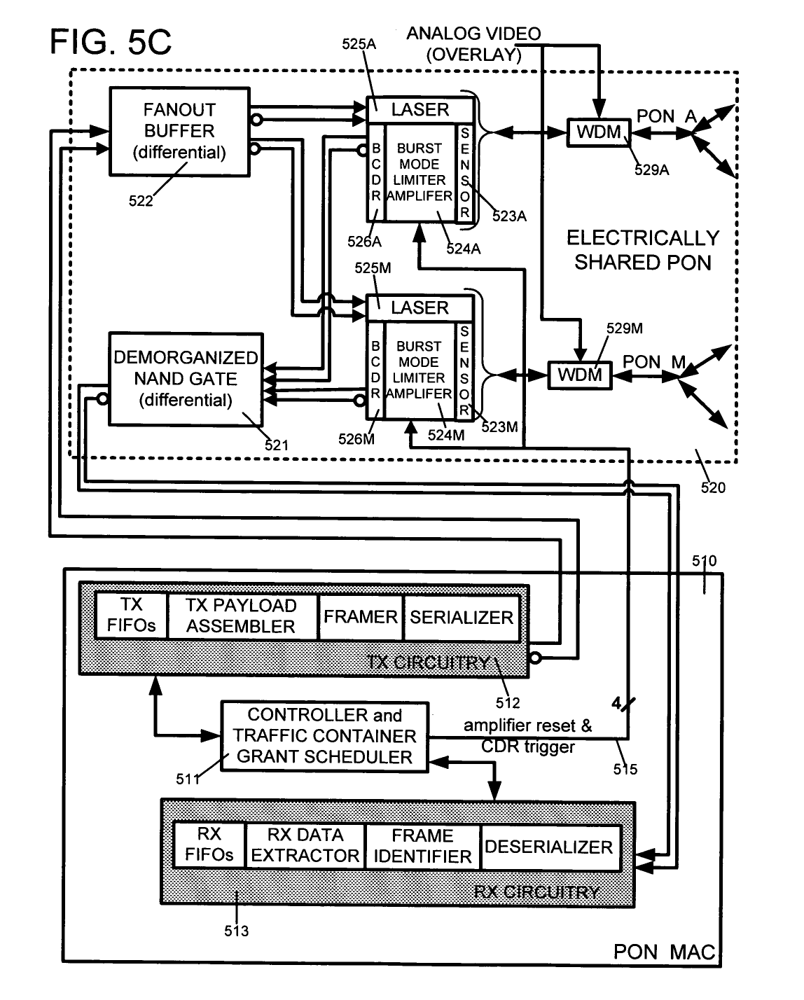

In one specific illustrative embodiment in accordance with the invention, a passive optical network (PON) media access controller (MAC) 510 (FIG. 5A) includes transmit circuitry 512, receive circuitry 513 and a circuit 511 that is coupled to each of circuitry 512 and 513. Circuit 511 includes a controller that generates one or more signals needed by each of circuitry 512 and 513 for their individual control thereof. Circuit 511 also includes a traffic container grant scheduler that generates timing signals for use of time slots by ONTs, and the timing is supplied as the amplifier reset signal on a bus 514 which is coupled to the burst mode limiter amplifiers 524A and 524M. The traffic container grant scheduler in circuit 511 includes a time slot allocation mechanism that allocates to each ONT a unique slot during which that ONT transmits upstream data. The allocated time slot is unique for each ONT so that each ONT may transmit without collision with any other ONT.

Transmit circuitry 512 typically includes one or more transmit FIFOs (first-in-first-out memories), that supply data to a transmit payload assembler. The transmit payload assembler in turn supplies the payload to a framer which creates a frame (composed of a header at the beginning of the frame, followed by payload, followed by a CRC word at the end of the frame). The framer provides the frame to a serializer that converts parallel data into serial data, usually in the form of a differential signal that is transmitted to a fanout buffer 522. Fanout buffer 522 supplies the signal, which is received from transmit circuitry 512, in identical form to each of two lasers 525A and 525M.

Lasers 525A and 525M independently generate an identical optical signal which is transmitted on their respective optical fibers to the respective PONs (namely PON A and PON M). In the embodiment illustrated in FIG. 5A, the just-described optical fibers are each connected through wave division multiplexers 529A and 529M that are used for adding an analog overlay (e.g. a cable television signal) prior to transmission on the downstream optical fiber to which are fused a number of optical fibers from a corresponding number of ONTs.

Receive circuitry 513 typically includes a deserializer that receives a differential signal from the demorganized NAND gate 521. The deserializer generates parallel data which is supplied to a burstmode clock data recovery module. The clock data recovery (BCDR) module acquires a unique bit pattern from the signal being sampled by sensor 523M. The unique bit pattern identifies that valid data is beginning. The BCDR module receives a trigger signal (similar to the “acquire” signal in U.S. Pat. No. 6,686,799) internally (i.e. within MAC 510) from the traffic container grant scheduler in circuit 511, which allows the BCDR module to more quickly acquire the unique bit pattern, than would be otherwise possible in its absence (e.g. if only the amplifier reset signal were to be used). Once the unique bit pattern has been detected, the BCDR module triggers a frame identifier module into operation which in turn parses the frame header and tail, and supplies the payload to a receive data extractor. The receive data extractor extracts the data within the payload and supplies the extracted data to receive FIFOs.

Each of fanout buffer 522 and demorganized NAND gate 521 are coupled to more than one transceiver, which in this illustrative embodiment happens to be two transceivers, as shown in FIG. 5A. The two transceivers in FIG. 5A include two lasers 525A and 525M, photo sensors 523A and 523M, and burst mode limiter amplifiers 524A and 524M. As noted above, each of the burst mode limiter amplifiers 524A and 524M has a reset bus 514 is coupled to circuit 511, to receive therefrom an amplifier reset signal. Burst mode limiter amplifiers 524A and 524M receive as data the electrical signals being generated by photo sensors 523A and 523M respectively. Burst mode limiter amplifiers 524A and 524M supply their respective output signals to demorganized NAND gate 521 that in turn combines these signals for supply to receive circuitry 513 within PON MAC 510.

Note that although in the embodiment illustrated in FIG. 5A the burstmode clock data recovery (BCDR) module is shown integrated into the PON MAC 510, in alternative embodiments illustrated in FIGS. 5B and 5C, a BCDR module is integrated into each transceiver. Specifically, BCDR modules 526A and 526M are shown in FIGS. 5B and 5C to be physically adjacent to and directly coupled to the respective burst mode limiter amplifiers 524A and 524M, and the output signal generated by BCDR modules 526A and 526M is supplied to the demorganized NAND gate 521. In the embodiment illustrated in FIG. 5B, the BCDR modules 526A and 526M use the above-described amplifier reset signal from bus 514 in acquiring the bit pattern. In contrast, in the embodiment illustrated in FIG. 5C, the BCDR modules 526A and 526M acquire the bit pattern by use of the above-described trigger signal (which is similar to the “acquire” signal in U.S. Pat. No. 6,686,799). In the embodiment of FIG. 5C, the PON MAC is designed to supply the trigger signal from circuit 511 on a 4-bit bus 517 (FIG. 5C) that also carries the amplifier reset signal to the burst mode limiter amplifiers 524A and 524M.

Note that the embodiments illustrated in FIGS. 5B and 5C show two different implementation details. It just so happens that a MAC vendor may partition their design as shown in FIG. 5B if an ASIC was designed to include the MAC logic and a burstmode clock data recovery (BCDR) module.

The design shown in FIG. 5C could be used by a vendor if their MAC logic were designed in an FPGA. Such an initial design by the vendor may eventually be converted into the design shown in FIG. 5B. But both design partitions can be used in either ASIC or FPGA if desired.

Although not shown in any drawing, a design for GPON would look just like the BPON diagrams shown in FIG. 4, except that the supported maximum bit rates are doubled or quadrupled, e.g. 622 mbps downstream goes up to 1.2 G or 2.4 G for GPON.

Numerous modifications and adaptations of the embodiments described herein will be apparent to the skilled artisan in view of the disclosure. For example, electrical splitter 220 can be any commercially available 1:N splitter that generates at its outputs N copies of an electrical signal received at its input, by use of one or more active components (e.g. differential components that consume power).

As another example, although OLT 400 has been described in detail in reference to Broadband PON, OLTs for other types of PONs such as APON, GPON, and EPON can also be implemented in a similar manner. Specifically, an EPON OLT can be built in the manner illustrated in FIG. 4 and as described in reference to FIG. 4, except that the transceivers do not require a reset signal and therefore a PECL to TTL Translator is not used in the EPON OLT. EPON transceivers are described in, for example, an article entitled “A Burst-Mode Receiver for 1.25 Gb/s Ethernet PON with AGC and Internally Created Reset Signal” by Quan Le et al, IEEE Journal of Solid State Circuits, Vol. 39, No. 12, December 2004 (that is incorporated by reference herein in its entirety).

Hence, numerous modifications and adaptations of the embodiments described herein are encompassed by the scope of the invention.

What is claimed is:

1. An apparatus comprising:
an optical line terminal (OLT) coupled to a plurality of groups of optical network terminals (ONTs);
wherein the OLT comprises a media access controller (MAC) having a transmit bus;
wherein said transmit bus of the MAC is coupled to a plurality of optical transceivers by at least one electrical splitter;
wherein each optical transceiver is coupled to one of the groups of ONTs by a passive optical network (PON); and
wherein each PON comprises at least one optical splitter.

2. The apparatus of claim 1 wherein:
the electrical splitter comprises a buffer having a single differential input and a plurality of differential outputs.

3. The apparatus of claim 1 wherein:
the OLT further comprises an OR operator; and
wherein each optical transceiver is coupled to an input terminal of the OR operator and an output terminal of the OR operator is coupled to a receive bus of the MAC.

4. A method comprising:
generating a PON signal to be transmitted over a passive optical network;
splitting the PON signal in electrical form;
transmitting in optical form a plurality of copies of the PON signal resulting from said splitting;
splitting at least one copy of an optical form of the PON signal resulting from said transmitting; and
a plurality of optical network terminals (ONTs) receiving the PON signal in optical form and extracting individual data addressed to each ONT from said PON signal in optical form.

5. The method of claim 4 wherein:
each ONT extracts its data from a predetermined slot relative to start of a frame in the PON signal.
